(19) United States
(12) Patent Application Publication
(10) Pub. No.: US 2025/0206228 A1
(43) Pub. Date: Jun. 26, 2025

(54) CONTROL DEVICE, CONTROL METHOD, AND NONTRANSITORY COMPUTER STORAGE MEDIUM

(71) Applicants: TOYOTA JIDOSHA KABUSHIKI KAISHA, Aichi-ken (JP); DENSO CORPORATION, Aichi-pref (JP)

(72) Inventor: Fumiya TAKAMARU, Toyota-shi (JP)

(21) Appl. No.: 18/977,936

(22) Filed: Dec. 12, 2024

(30) Foreign Application Priority Data
Dec. 20, 2023 (JP) 2023-214966

(51) Int. Cl. B60R 1/22

(52) U.S. Cl. CPC B60R 1/22; B60R 2300/404

(57) ABSTRACT

A control device is configured to content a display content of a display device having an input device. The control device is configured to switch the display content of the display device to a specific display content when a predetermined switching condition stands and not switch the display content of the display device to the specific display content even if the predetermined switching condition stands when it is judged that an input operation has been performed through the input device.

### FIELD

The present disclosure relates to a control device, control method, and non-transitory computer storage medium.

### BACKGROUND

Japanese Unexamined Patent Publication No. 2009-279957 discloses a conventional display switching device in which, when an image switching condition stands, an image displayed on a display device in the vehicle compartment is switched to a camera image captured by a vehicle-mounted surrounding monitoring camera.

### SUMMARY

However, in the above-mentioned display switching device, if the image switching condition stood, the image on the display device was liable to switch to the camera image even if some sort of input operation was performed on the display device.

The present disclosure was made focusing on such a problem and has as its object to keep the display content of a display device from switching to another display content unrelated to an input operation of the display device during such an input operation.

To solve the above problem, according to one aspect of the present disclosure, there is provided a control device configured to control a display content of a display device having an input device. The control device is configured to switch the display content of the display device to a specific display content when a predetermined switching condition stands and not switch the display content of the display device to the specific display content even if the predetermined switching condition stands when it is judged that an input operation has been performed through the input device.

Further, according to another aspect of the present disclosure, there is provided a control method controlling a display content of a display device having an input device. The control method comprises switching the display content of the display device to a specific display content when a predetermined switching condition stands, and not switching the display content of the display device to the specific display content even if the predetermined switching condition stands when it is judged that an input operation has been performed through the input device.

Further, according to another aspect of the present disclosure, there is provided a nontransitory computer storage medium including a computer program for causing by a processor to execute a process of controlling a display content of a display device having an input device, switching the display content of the display device to a specific display content when a predetermined switching condition stands, and not switching the display content of the display device to the specific display content even if the predetermined switching condition stands when it is judged that an input operation has been performed through the input device.

According to these aspects of the present disclosure, it is possible to keep the display content of a display device from switching to another display content unrelated to an input operation of the display device during such an input operation.

### BRIEF DESCRIPTION OF DRAWINGS

FIG. 1 is a schematic view of the configuration of a driver assist device according to one embodiment of the present disclosure.

FIG. 2 is a flow chart for explaining details of automatic switching control according to one embodiment of the present disclosure.

### DESCRIPTION OF EMBODIMENTS

Below, an embodiment of the present disclosure will be explained in detail with reference to the drawings. Note that, in the following explanation, similar component elements will be assigned the same reference numerals.

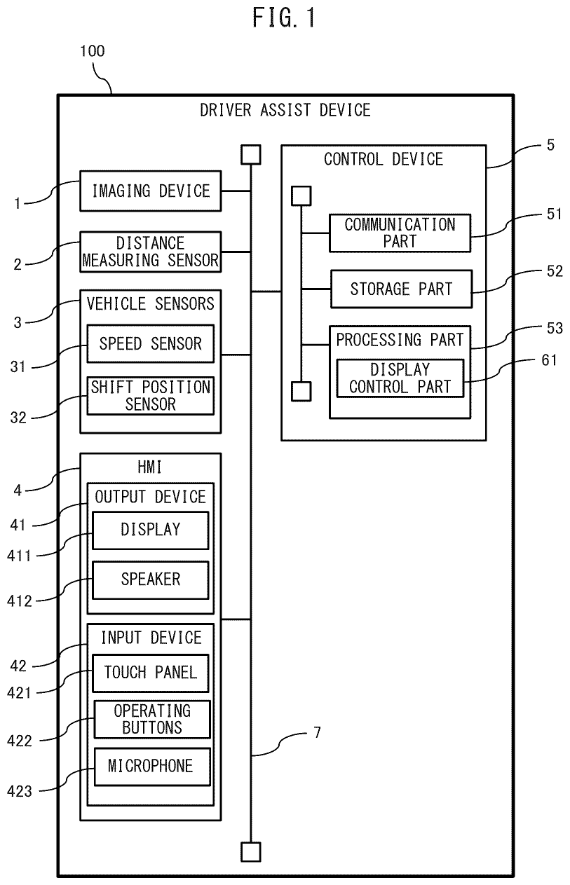

FIG. 1 is a schematic view of the configuration of a driver assist device 100 according to one embodiment of the present disclosure.

The driver assist device 100 is provided with an imaging device 1, distance measuring sensor 2, vehicle sensors 3, HMI (human machine interface) 4, and control device 5. The imaging device 1, distance measuring sensor 2, vehicle sensors 3, HMI 4, and control device 5 are connected to be able to communicate through an internal vehicle network 7 based on the Control Area Network standard.

The imaging device 1 is provided with one or more external cameras for capturing the surroundings of the vehicle being given driver assist by the driver assist device 100 (below, referred to as the “host vehicle”). The imaging device 1 captures the surroundings of the host vehicle by a predetermined frame rate (for example, 10 [Hz] to 40 [Hz]) and generates an image of the surroundings in which the surroundings of the host vehicle are reflected (for example, a panoramic view or front view, two side views, back view, and other images). The imaging device 1 sends the generated image of the surroundings as captured data to the control device 5 each time generating an image of the surroundings.

The distance measuring sensor 2 measures the distance to another vehicle or a pedestrian or other object present in the surroundings of the host vehicle and sends the measured distance data to the control device 5. As examples of a distance measuring sensor 2, for example, a lidar (light detection and ranging) device for firing a radar beam and measuring distance based on the reflected light, a millimeter wave radar sensor for emitting a radio wave and measuring distance based on the reflected wave etc. may be mentioned.

The vehicle sensors 3 are sensors for generating vehicle data showing the status of the host vehicle. In the present embodiment, as vehicle sensors 3, for example, a speed sensor 31 for generating speed data showing the running speed (vehicle speed) of the host vehicle, a shift position sensor 32 for generating shift position data showing a shift position of the host vehicle (for example, P range, N range, D range, R range, etc.), etc. are provided. However, the vehicle sensors 3 are not limited to these sensors 31, 32. The vehicle sensors 3 send the acquired speed data and other various data as vehicle data to the control device 5.

The HMI 4 is a user interface for transfer of information between the host vehicle and its occupants. The HMI 4 is one example of a display device. The HMI 4 is provided with an output device 41 for providing notifications and information to the vehicle occupants through the physical senses of the vehicle occupants (for example, sight, hearing, touch, etc.) and an input device 42 for a vehicle occupant to perform input operations. In the present embodiment, as the output device 41, for example, a meter display or center display, heads up display, or other display 411 and a speaker 412 are provided. Further, as the input device 42, a touch panel 421, operating buttons 422, and microphone 423 are provided.

The HMI 4 displays information corresponding to a display signal received from the control device 5 (for example, text information or graphic information) on the display 411 and outputs a sound corresponding to an audio signal from the speaker 412. Further, the HMI 4 sends operating data corresponding to an input operation performed by a vehicle occupant through the input device 42 to the control device 5.

The HMI 4 may be mounted in the host vehicle in advance or may be a smartphone or other terminal held by a vehicle occupant. In the latter case, for example, information may be transferred by short distance wireless between the host vehicle and terminal of the vehicle occupant, the terminal of the vehicle occupant and an outside server (not shown) may communicate with each other, and information may be transferred indirectly through the server.

The control device 5 is an ECU (electronic control unit) provided with a communication part 51, storage part 52, and processing part 53.

The communication part 51 is provided with an interface circuit for connecting the control device 5 to an internal vehicle network 7. The communication part 51 supplies the various types of data received from the imaging device 1 or the sensors 2, 3, HMI 4, etc. to a processing part 53. Further, the communication part 51 outputs the various display signals output from the processing part 53 to the HMI 4.

The storage part 52 has an HDD (hard disk drive), SSD (solid state drive), semiconductor memory, or other storage medium and stores various computer programs and data etc. used for processing at the processing part 53.

The processing part 53 has one or more CPUs (central processing units) and their peripheral circuits and runs various types of computer programs stored in the storage part 52. The processing part 53 is, for example, a processor and may further having other processing circuits such as logical operation units, numerical operation units, or graphic processing units. The processing part 53 performs processing in accordance with a computer program to thereby function as a display control part 61 and operate as a function part (module) for realizing a predetermined function. In the following explanation, if explaining processing with the display control part 61 as the subject, this will show the processing part 53 running a program for realizing the display control part 61.

Below, the content of the specific processing performed at the control device 5 will be explained. That is, the content of the display control part 61 realized by the processing part 53 performing processing in accordance with a program will be explained.

The display control part 61 controls the display content of the display 411 to a display content corresponding to an input operation of a vehicle occupant.

Further, the display control part 61 automatically switches the display content of the display 411 to an image of the surroundings of the host vehicle so as to assist driving by the driver when a predetermined image switching condition stands. As the image switching condition, for example, the vehicle speed becoming a low speed of less than a predetermined speed, a shift position being switched to a forward range (in the present embodiment, N range and D range), a shift position being switched to a reverse range (in the present embodiment, R range), an object with a distance with the host vehicle of less than a predetermined distance being detected, etc. may be mentioned.

Here, when a vehicle occupant is performing an input operation based on the display content of the display 411, if a screen switching condition stands and the display content of the display 411 ends up being switched to an image of the surroundings, the input operation will be interrupted and a new input operation for returning to the original display content from the image of the surroundings will become necessary. For this reason, the vehicle occupant is liable to feel bothered by this driver assist of automatically switching the display content of the display 411 to an image of the surroundings of the vehicle.

Therefore, in the present embodiment, when an input operation is performed through the input device 42, automatic switching control for automatically switching the display content of the display 411 to an image of the surroundings of the host vehicle was suppressed.

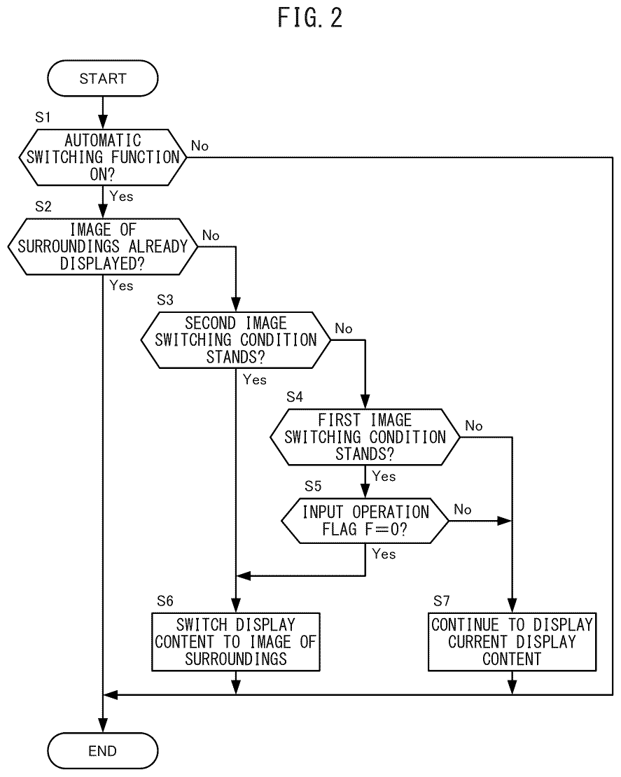

FIG. 2 is a flow chart for explaining details of automatic switching control according to the present embodiment. The control device 5 repeatedly performs the present routine at predetermined processing cycles.

At step S1, the control device 5 judges whether an automatic switching function is in the ON state. An automatic switching function is a function of automatically switching a display content of the display 411 to an image of the surroundings of the host vehicle when an image switching condition stands. The automatic switching function can for example be switched to the ON state or the OFF state by a vehicle occupant performing an input operation through the input device 42. If the automatic switching function is in the ON state, the control device proceeds to the processing of step S2. On the other hand, if the automatic switching function is in the OFF state, the control device 5 ends the current processing.

At step S2, the control device 5 judges whether the display 411 is already showing an image of the surroundings. If the display 411 is already showing an image of the surroundings, the control device 5 ends the current processing. If the display 411 is not already showing an image of the surroundings, the control device 5 proceeds to the processing of step S3.

At step S3, the control device 5 judges if a predetermined second image switching condition among the image switching conditions stands. In the present embodiment, the control device 5 judges that a second image switching condition stands if the shift position has been switched to the reverse range (in the present embodiment, the R range) or if an object with a distance from the host vehicle of less than a predetermined distance has been detected. If the second switching condition stands, the control device 5 proceeds to the processing of step S6. On the other hand, if the second switching condition does not stand, the control device 5 proceeds to the processing of step S4.

At step S4, the control device 5 judges if a predetermined first image switching condition among the image switching conditions stands. In the present embodiment, the control device 5 judges that the first image switching condition stands if the vehicle speed has become a low speed of less than a predetermined speed or if the shift position has been switched from another range to the forward range. If the first image switching condition stands, the control device 5 proceeds to the processing of step S5. On the other hand, if the first image switching condition does not stand, the control device 5 proceeds to the processing of step S7.

At step S5, the control device 5 judges whether an input operation flag F is set to 0. An input operation flag F is a flag which is set to 1 for exactly a fixed time TF1 if it is judged that an input operation has been performed through the input device 42. The initial value is set to 0. That is, the input operation flag F is a flag which is switched from 0 to 1 if an input operation has been performed through the input device 42 and which is returned to 0 after a fixed time TF1 has elapsed. If the input operation flag F is set to 0, the control device 5 proceeds to the processing of step S6. On the other hand, if the input operation flag F is set to 1, the control device 5 proceeds to the processing of step S7.

Note that, as input operations, for example, one where a button on a touch panel 421 or an operating button 422 etc. is pressed just one time or another one which ends with a single brief input operation (below, for convenience, referred to as a “first input operation”), for example, one where a drag operation or pinch-in operation, pinch-out operation, or other operation is performed on a touch panel 421 or another one which ends with a single input operation, but whose operation is extended and requires a certain extent of time (below, for convenience, referred to as a “second input operation”), and, for example, one where buttons on a touch panel 421 or operating buttons 422 etc. are used to change various settings or another one where a consecutive number of input operations become required (below, for convenience, referred to as a “third input operation”) may be considered to exist.

A vehicle occupant would conceivably feel bothered, in particular when performing a second input operation and a third input operation, if the display content of the display 411 were to be automatically switched to an image of the surroundings since the operation would be interrupted. Therefore, in the present embodiment, when a single input operation was continued to be performed for greater than or equal to a predetermined time period and an input operation was performed greater than or equal to a predetermined number of times within a predetermined time period, it is judged that an input operation has been performed and an input operation flag F is set to 1 for exactly a fixed time TF1. Due to this, it is possible to keep switching to images of the surrounding from ending up being suppressed more than necessary, so more suitable driver assist becomes possible. Of course, more simply, it is also possible to judge that an input operation has been performed each time an input operation is once performed.

At step S6, the control device 5 switches the display content of the display 411 to an image of the surroundings. In the present embodiment, the image of the surroundings is for example a panoramic view or other composite image generated based on images captured by the imaging device 1, but it may also be an image directly captured by the imaging device 1.

At step S7, the control device 5 continues to display the current display content without switching the display content of the display 411 to an image of the surroundings.

In this way, in the present embodiment, if a first image switching condition stands, the display content of the display 411 is made to not be switched to an image of the surroundings if it is judged that an input operation has been performed. Due to this, the input operation is not made to be interrupted, so it is possible to keep the person inputting the operation from feeling bothered.

On the other hand, if a second image switching condition stands, the display content of the display 411 is made to be switched to an image of the surroundings even if it is judged that an input operation has been performed. This is because it is believed that when a second image switching condition stands, it is preferable safety wise to display the image of the surroundings even if interrupting the input operation.

The control device 5 for controlling the display content of the HMI 4 (display device) having the input device 42 according to the present embodiment explained above is configured to switch the display content of the HMI 4 to a specific display content when a predetermined first switching condition (switching condition) stands and to not switch the display content of the HMI 4 to a specific display content even if the first switching condition stands when it is judged that an input operation has been performed through the input device 42.

Due to this, during an input operation of the HMI 4, it is possible to keep the display content of the HMI 4 from being switched to another display content not related to the input operation. For this reason, the input operation can be kept from being interrupted, so it is possible to keep the person inputting the operation from feeling bothered.

Further, the control device 5 according to the present embodiment is configured so as to judge that an input operation has been performed if an input operation has been performed for greater than or equal to a predetermined number of times within a predetermined time period or if an input operation has been continued to be performed for a predetermined time period or more.

Due to this, it is possible to precisely detect an input operation being underway and keep display content from ending up being switched while the input operation is underway.

Further, in the present embodiment, the HMI 4 is mounted in a vehicle, and the specific display content is an image captured by an imaging device 1 capturing an outside of the vehicle or a composite image generated based on that image. Further, the control device 5 according to the present embodiment is configured to switch the display content of the HMI 4 to a specific display content even if a predetermined second switching condition different from the first switching condition stands and switch the display content of the HMI 4 to the specific display content even if it is judged that the input operation has been performed when the second switching condition stands. The first switching condition includes at least one of a speed of the vehicle at which the HMI 4 is mounted being less than a predetermined speed and a shift position of the vehicle being a forward range, and the second switching condition includes at least one of a shift position of the vehicle being a reverse range and an object with a relative distance with the vehicle of less than a predetermined distance being detected.

Due to this, it is possible to keep an input operation from being interrupted while making an image of the surroundings be displayed when it is believed preferable safety wise to display the image of the surroundings even if interrupting the input operation.

Above, embodiments of the present disclosure were explained, but the embodiments only show some of the applications of the present disclosure and are not meant to limit the technical scope of the present disclosure to the specific configurations of the embodiments.

For example, in the above embodiments, the computer programs run at the control device 5 (for example, automatic switching control) may be provided in a form recorded at a computer readable portable recording medium such as a semiconductor memory, magnetic recording medium, or optical recording medium.

1. A control device configured to control a display content of a display device having an input device, wherein
the control device is configured to:
switch the display content of the display device to a specific display content when a predetermined switching condition stands; and
not switch the display content of the display device to the specific display content even if the predetermined switching condition stands when it is judged that an input operation has been performed through the input device.

2. The control device according to claim 1, wherein
the display device is mounted in a vehicle, and
the specific display content is an image captured by an imaging device capturing an outside of the vehicle or a composite image generated based on that image.

3. The control device according to claim 1, wherein
the control device is configured to judge that the input operation has been performed if the input operation has been performed for greater than or equal to a predetermined number of times within a predetermined time period or if the input operation has been continued to be performed for a predetermined time period or more.

4. The control device according to claim 1, wherein
the control device is configured to:
switch the display content of the display device to a specific display content even if a predetermined second switching condition different from the switching condition stands; and
switch the display content of the display device to the specific display content even if it is judged that the input operation has been performed when the second switching condition stands.

5. The control device according to claim 4, wherein
the switching condition includes at least one of a speed of the vehicle at which the display device is mounted being less than a predetermined speed and a shift position of the vehicle being a forward range, and
the second switching condition includes at least one of a shift position of the vehicle being a reverse range and an object with a relative distance with the vehicle of less than a predetermined distance being detected.

6. A control method controlling a display content of a display device having an input device, wherein
the control method comprises:
switching the display content of the display device to a specific display content when a predetermined switching condition stands; and
not switching the display content of the display device to the specific display content even if the predetermined switching condition stands when it is judged that an input operation has been performed through the input device.

7. A nontransitory computer storage medium including a computer program for causing by a processor to execute a process of:
controlling a display content of a display device having an input device;
switching the display content of the display device to a specific display content when a predetermined switching condition stands; and
not switching the display content of the display device to the specific display content even if the predetermined switching condition stands when it is judged that an input operation has been performed through the input device.
